(19) United States
(12) Patent Application Publication
(10) Pub. No.: US 2026/0075128 A1
(43) Pub. Date: Mar. 12, 2026

(54) Mobile Phone Case

(71) Applicant: Casetagram Limited, Hong Kong (HK)

(72) Inventors: Pui Sun Wesley Ng, Hong Kong (HK); Satoshi Matsudaira, Hong Kong (HK)

(21) Appl. No.: 19/319,787

(22) Filed: Sep. 5, 2025

(30) Foreign Application Priority Data
Sep. 6, 2024 (CN) 202422198309.8

(51) Int. Cl. H04M 1/02; H04M 1/04

(52) U.S. Cl. CPC H04M 1/0203; H04M 1/04

(57) ABSTRACT

A mobile phone case includes a case back panel and a case frame fixedly connected to the case back panel, wherein the case back panel and the case frame are two independently formed components; wherein a plurality of through-portions are disposed at intervals around periphery of the case back panel; and a plurality of connecting portions, present in the same number as the plurality of through-portions, are disposed at intervals on a side of the case frame; wherein each of the plurality of connecting portions is correspondingly embedded in one of the plurality of through-portions to fixedly connect the case back panel to the case frame.

### CROSS REFERENCE TO RELATED APPLICATIONS

The present application claims the benefit of Chinese Patent Application No. 202422198309.8 filed on September 6, 2024, the contents of which are incorporated herein by reference in their entirety.

### FIELD OF TECHNOLOGY

The present application relates to a mobile phone case, and more particularly, a mobile phone case of which the case back panel and the case frame are securely connected.

### BACKGROUND

Existing mobile phone cases include a case back panel and a case frame. Typically, the case back panel and the case frame are manufactured as an integrated structure using conventional injection molding. Mobile phone cases manufactured by such a method have a monotonous and outdated appearance, lacking appeal to the diverse tastes among young people nowadays. Furthermore, the molds used to manufacture such mobile phone cases are relatively expensive.

### SUMMARY

The technical problem sought to be addressed by the present application is to provide a mobile phone case that can connect the case back panel and the case frame, which are in separate phases, to form a mobile phone case with high strength and strong visual sense of three-dimensionality.

To address the above-mentioned technical problem, the present application has adopted the following technical solutions:

A mobile phone case according to one embodiment of the present application, includes a case back panel and a case frame fixedly connected to the case back panel, wherein the case back panel and the case frame are two independently formed components; wherein a plurality of through-portions are disposed at intervals around periphery of the case back panel; and a plurality of connecting portions, present in the same number as the plurality of through-portions, are disposed at intervals on a side of the case frame; wherein each of the plurality of connecting portions is correspondingly embedded in one of the plurality of through-portions to fixedly connect the case back panel to the case frame.

In a preferred embodiment, the case frame is an injection molded part connected to the case back panel by injection molding.

In a preferred embodiment, the case frame is an independently formed component, and is connected to the case back panel by an adhesive structure.

In a preferred embodiment, the through-portion is a circular hole, an elliptical hole or a regular polygonal hole, and the outer diameter of the through-portion is 0.5-2.5 mm.

In a preferred embodiment, the through-portion is an elliptical hole having a maximum outer diameter of 1.5-2.5 mm and a minimum outer diameter of 0.5-1.0 mm.

In a preferred embodiment, the through-portion is an elliptical hole having a hole size of 0.9 mm × 2.0 mm.

In a preferred embodiment, a spacing between two adjacent through-holes is 5-25 mm.

In a preferred embodiment, a spacing between two adjacent through-holes is 10-15 mm.

In a preferred embodiment, the case frame further includes a covering portion, the covering portion and the connecting portion are an integral structure, and the covering portion completely covers openings at both ends of each of the through-portions of the case back panel.

In a preferred embodiment, the mobile phone case further includes a mortise and tenon interlocking structure disposed between the case back panel and the case frame to connect the case back panel and the case frame.

Compared to the existing technology, the present application securely connects the individual case back panel and case frame together through a male-female interlocking structure between the plurality of through-portions on the case back panel and the connecting portions disposed on the case frame. This not only strengthens the connection between the case back panel and the case frame, but also advantageously simplifies the manufacturing process of the mobile phone case. Furthermore, when the case back panel and the case frame are made of transparent materials of different colors, the male-female interlocking structure between the through-portions and the connecting portions can provide a strong visual sense of three-dimensionality to the user.

### BRIEF DESCRIPTION OF THE DRAWINGS

FIG. 1 is a schematic view of the case back panel of the mobile phone case according to one embodiment of the present application.

FIG. 2 is a partial cross-sectional side view of the mobile phone case in FIG. 1 when lying flat.

FIG. 3 is an enlarged schematic view of section A in FIG. 2.

FIG. 4 is an enlarged schematic view of the mortise and tenon interlocking structure between the case back panel and the case frame.

The reference numerals of in the drawings are as follows:

Case back panel 1; case frame 2; through-portion 3; groove 4; mortise and tenon interlocking structure 5; lens frame 6; magnetic ring 7; connecting portion 8; covering portion 9.

### DETAILED DESCRIPTION

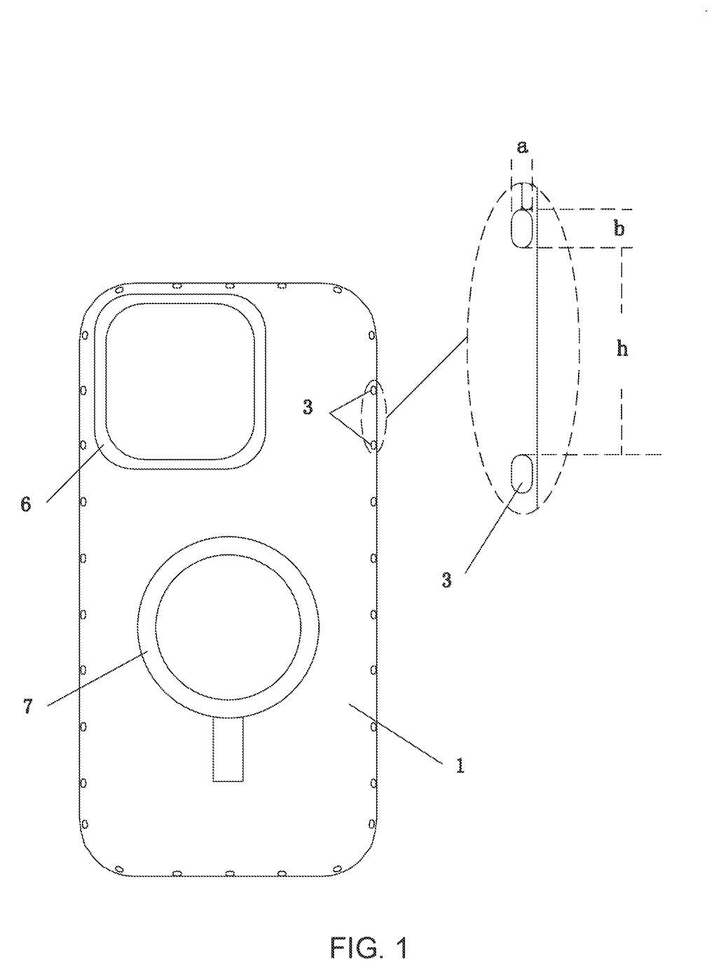

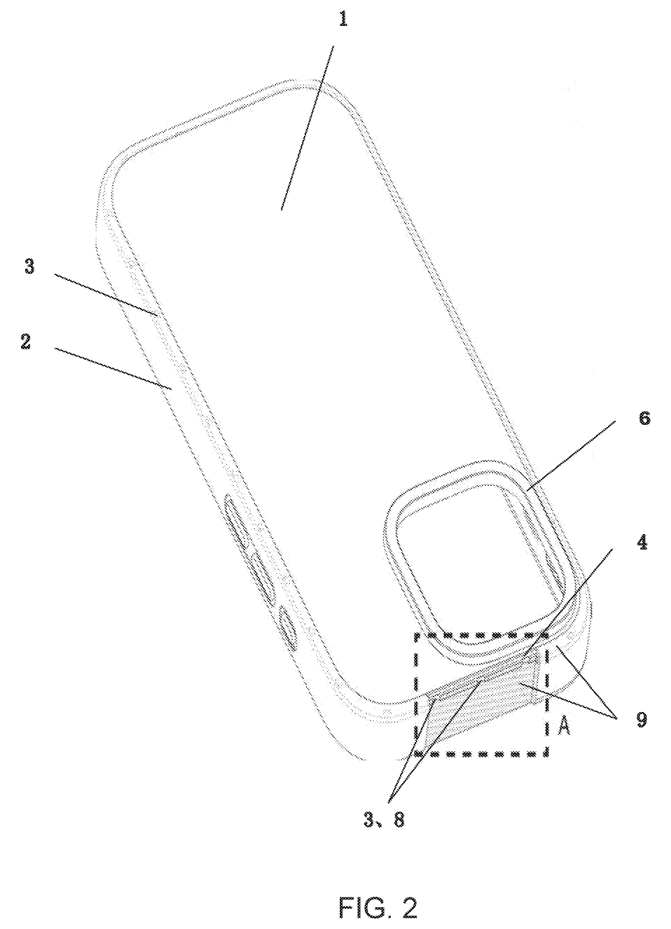

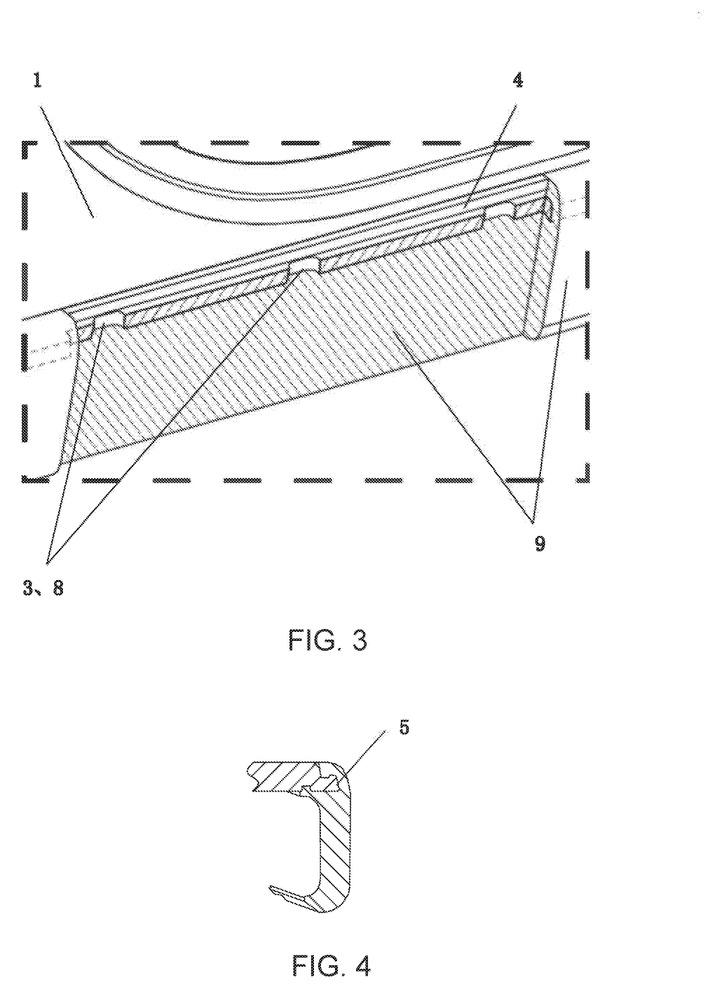

As shown in FIGS. 1-4, the mobile phone case of the present application includes a case back panel 1 and a case frame 2.

1. Case back panel 1 is a prefabricated finished part, which can be made of plastic or metallic materials, and can be a single color or a combination of multiple colors.

The case back panel 1 is equipped with a conventional lens frame 6 and magnetic ring 7. The case back panel 1 is rectangular in shape, with an annular groove 4 extending along its perimeter. A plurality of through-portions 3 are spaced along the perimeter within the groove 4, extending through the through-portions 3 of the case back panel 1. The through-portions 3 can have various shapes, including circular, elliptical, and regular polygonal.

The maximum outer diameter of the through-portions 3 is 2.5 mm. In the present application, the through-portions 3 are preferably elliptical, with a maximum outer diameter b of 1.5-2.5 mm and a minimum outer diameter a of 0.5-1.0 mm, preferably a × b = 0.9 mm × 2.0 mm. The spacing h between two adjacent through-portions 3 is 5-25 mm, preferably 10 mm-15 mm. The aperture of the through-portion 3 and the spacing between two adjacent through-portions 3 ensure a relatively high connection strength when the case back panel 1 and the case frame 2 are connected together, while also preventing fracture between the edge of the case back panel 1 and the main body of the mobile phone case due to the formation of multiple through-portions 3 which resembles indentation line.

Furthermore, to enhance the connection strength between the case back panel 1 and the case frame 2, interlocking mortise and tenon structures 5 that connects the case back panel 1 and the case frame 2 may be provided in certain areas between the case back panel 1 and the case frame 2, such as at the corners.

2. Case frame 2

There are two types of case frame 2:

1) Using injection molding, molten plastic is injected into a frame mold mounted on the case back panel 1.

When the molten plastic injected into the frame mold cools down, a number of connecting portions 8 present in the same number as the number of through-portions 3 will be formed around the perimeter of the case frame 2. These connecting portions 8 will be inserted into the corresponding through-portions 3, thereby connecting the case back panel 1 to the case frame 2. Simultaneously, after the molten plastic cools down, annular connecting ribs will also be formed within the grooves 4 of the case back panel 1, and the case back panel 1 and the case frame will be formed as one.

2) The case frame 2 is a prefabricated finished product, with a number of connecting portions 8 around its perimeter, the connecting portions 8 being present in the same number as the number of through-portions 3. During assembly of the phone case, a chemical adhesive is applied to the perimeter of the case frame 2. The connecting portions 8 on the case frame 2 are then inserted into the corresponding through-portions 3, securing the case back panel 1 to the case frame 2.

What is claimed is:

1. A mobile phone case comprising a case back panel and a case frame fixedly connected to the case back panel,
wherein the case back panel and the case frame are two independently formed components;
wherein a plurality of through-portions are disposed at intervals around periphery of the case back panel; and a plurality of connecting portions, present in the same number as the plurality of through-portions, are disposed at intervals on a side of the case frame;
wherein each of the plurality of connecting portions is correspondingly embedded in one of the plurality of through-portions to fixedly connect the case back panel to the case frame.

2. The mobile phone case according to claim 1, wherein the case frame is an injection molded part connected to the case back panel by injection molding.

3. The mobile phone case according to claim 1, wherein the case frame is an independently formed component, and is connected to the case back panel by an adhesive structure.

4. The mobile phone case according to claim 2, wherein the through-portion is a circular hole, an elliptical hole or a regular polygonal hole, and the outer diameter of the through-portion is 0.5-2.5 mm.

5. The mobile phone case according to claim 2, wherein the through-portion is an elliptical hole having a maximum outer diameter of 1.5-2.5 mm and a minimum outer diameter of 0.5-1.0 mm.

6. The mobile phone case according to claim 2, wherein the through-portion is an elliptical hole having a hole size of 0.9 mm × 2.0 mm.

7. The mobile phone case according to claim 4, wherein a spacing between two adjacent through-holes is 5-25 mm.

8. The mobile phone case according to claim 4, wherein a spacing between two adjacent through-holes is 10-15 mm.

9. The mobile phone case according to claim 5, wherein a spacing between two adjacent through-holes is 5-25 mm.

10. The mobile phone case according to claim 5, wherein a spacing between two adjacent through-holes is 10-15 mm.

11. The mobile phone case according to claim 6, wherein a spacing between two adjacent through-holes is 5-25 mm.

12. The mobile phone case according to claim 4, wherein the case frame further comprises a covering portion, the covering portion and the connecting portion are an integral structure, and the covering portion completely covers openings at both ends of each of the through-portions of the case back panel.

13. The mobile phone case according to claim 5, wherein the case frame further comprises a covering portion, the covering portion and the connecting portion are an integral structure, and the covering portion completely covers openings at both ends of each of the through-portions of the case back panel.

14. The mobile phone case according to claim 6, wherein the case frame further comprises a covering portion, the covering portion and the connecting portion are an integral structure, and the covering portion completely covers openings at both ends of each of the through-portions of the case back panel.

15. The mobile phone case according to claim 7, wherein the case frame further comprises a covering portion, the covering portion and the connecting portion are an integral structure, and the covering portion completely covers openings at both ends of each of the through-portions of the case back panel.

16. The mobile phone case according to claim 8, wherein the case frame further comprises a covering portion, the covering portion and the connecting portion are an integral structure, and the covering portion completely covers openings at both ends of each of the through-portions of the case back panel.

17. The mobile phone case according to claim 9, wherein the case frame further comprises a covering portion, the covering portion and the connecting portion are an integral structure, and the covering portion completely covers openings at both ends of each of the through-portions of the case back panel.

18. The mobile phone case according to claim 10, wherein the case frame further comprises a covering portion, the covering portion and the connecting portion are an integral structure, and the covering portion completely covers openings at both ends of each of the through-portions of the case back panel.

19. The mobile phone case according to claim 11, wherein the case frame further comprises a covering portion, the covering portion and the connecting portion are an integral structure, and the covering portion completely covers openings at both ends of each of the through-portions of the case back panel.

20. The mobile phone case according to claim 4, further comprising a mortise and tenon interlocking structure disposed between the case back panel and the case frame to connect the case back panel and the case frame.
